(19) United States
(12) Patent Application Publication
(10) Pub. No.: US 2017/0197560 A1
(43) Pub. Date: Jul. 13, 2017

(54) TRIM COMPONENT FOR A VEHICLE AND A TRIM COMPONENT FOR A VEHICLE'S TRUNK

(71) Applicant: Ford Global Technologies, LLC, Dearborn, MI (US)

(72) Inventors: Vic Kong, Nanjing (CN); Peter Zhang, Nanjing (CN); Tom Xu, Nanjing (CN); Jeffrey Dai, Nanjing (CN)

(21) Appl. No.: 15/400,020

(22) Filed: Jan. 6, 2017

(30) Foreign Application Priority Data
Jan. 12, 2016 (CN) 201610019203.4

(51) Int. Cl. B60R 13/02

(52) U.S. Cl. CPC B60R 13/0275; B60R 13/0206

(57) ABSTRACT

A trim component in a vehicle comprises a bezel and a gap cover. The bezel includes a first end and a second end spaced apart from the first end by an installation gap. The gap cover is pivotally connected to the first end and moveable between an open position and a closed position and conceals the installation gap at the closed position.

### RELATED APPLICATION

This application claims the benefit of Chinese Patent Application No.: CN 201610019203.4 filed on Jan. 12, 2016, the entire contents thereof being incorporated herein by reference.

### TECHNICAL FIELD

This invention relates to a vehicle, in particular, relates a trim component used in a vehicle and a trim component used in a vehicle's trunk.

### BACKGROUND

In a vehicle, trial components are commonly used to cover installation opens to obtain better appearance. For example, a vehicle's trunk s pivotally hinged to a trunk body via a hinge shaft. A trim bezel is usually used to cover an opening to receive the hinge shaft.

FIGS. 1 and 2 show a ring-shaped trim bezel conventionally used in a vehicle's trunk 6. A trim component 1 includes a bezel 2 with a cut 3, and the cut 3 of the bezel 2 forms an installation gap. FIG. 1 also shows a hinge shaft 4 disposed in an opening 5. During an installation, the bezel 2 is opened at the cut 3 to encircle the hinge shaft 4 and then is deformed by a force to be squeezed into a predetermined lace surrounding the opening 5 to be assembled. The visibility of the cut 3 or the installation gap can cause unsatisfactory appearance.

### SUMMARY OF THE INVENTION

The present disclosure provides a trim component which can conceal an installation gap. According to one aspect, the trim component comprises a bezel having a first end and a second end spaced apart from the first end by an installation gap; and a gap cover pivotally connected to the first end. The gap cover conceals the gap when the gap cover is pivotally moved to a position connected with the second end of the bezel.

In one embodiment, the gap cover is fixed to the second end or detachably connected to the second end.

In another embodiment, the gap cover includes a base and an insertion member extended from a bottom surface of the base, and the second end has an insertion hole to receive the insertion member to be connected to the gap cover.

In another embodiment, the second end include a receiving slot, and the base is partially received in the receiving slot and the insertion hole is formed on a bottom portion of the second end that defines the receiving slot.

In another embodiment, the insertion member includes a middle portion at least partially received in the insertion hole and a stop extending from a radial direction of the middle portion. The middle portion is disposed in the insertion hole and the stop is disposed under a bottom surface of the second end when the gap cover is at a position to conceal the installation gap.

In another embodiment the insertion member and the insertion hole are connected by clearance fit.

In another embodiment, the gap cover is detachably connected to the second end via a hook-loop or snap fitting.

In another embodiment, an auto-lock is disposed between the gap cover and the second end, both parts are detachably connected via the auto-lock.

In another embodiment, the gap cover and bezel are integrally formed.

In another embodiment, the gap cover includes a connection portion having a thickness and the connection of the connection portion and the first end consists a pivot rotation of the gap cover.

In another embodiment, at position concealing the installation gap, a top surface of the gap cover is aligned with a top surface of the bezel.

In another embodiment, at the position concealing the installation gap, two sidewalls of the gap cover are aligned with inner sidewall and an outer sidewall of the bezel.

According to another aspect, a trim component in a vehicle is provided. The trim component comprises a looped bezel including a first end and a second end spaced apart from the first end by an installation gap; and a gap cover pivotally connected to the first end of the bezel, wherein the gap cover is moveable between an open position and a closed position and configured to conceal the installation gap at the closed position.

In one embodiment, the second end includes a bottom portion recessed from a top surface of the bezel. An upper surface of the bottom portion and a sidewall above the upper surface define a receiving slot, and the gap cover is disposed in the receiving slot at the closed position.

In another embodiment, the gap cover includes a base and an insertion member extended from a bottom surface of the base. The bottom portion of the second end includes an insertion hole, and the insertion member is positioned in the insertion hole at the closed position.

In another embodiment, the insertion member includes a middle portion having a length greater than thickness of the insertion hole and a stop disposed on at an end of the insertion member and extending from a radial direction of the middle portion. The stop is disposed under a bottom surface of the second end to fix the gap cover on the second end of the bezel at the closed position.

In another embodiment, the gap cover and the bezel are integrally formed, and the gap cover includes a connection portion adjacent to the first end and having a minimum thickness. The connection portion constitutes a pivot for rotation of the gap cover.

According to another aspect, a trim component in a vehicle's trunk is provided. The trim component comprises a bezel connected to an inner trim of the trunk and surrounding a hinge shaft of the trunk, and includes a first end and a second part spaced apart by an installation gap. The trim component further includes a gap cover pivotally connected to the first end of the bezel and moveable between an open position and a closed position.

In one embodiment, the first end and the second end of the bezel are configured to be moveable relative each other at the open position such that the bezel is capable of being pass through the hinge shaft and being positioned on an opening on the inner trim.

In another embodiment, the gap cover is detachable connected to the second end or secured to the second end at the closed position, and the gap cover conceals the installation gap at the closed position.

The trim component of the present disclosure is advantageous because it has a gap cover pivotally connected to one end of a bezel. The installing gap of the bezel is concealed when the gap cover is positioned into the installation gap. As such, the installing gap is invisible, and thus to provide better appearance of the trim component.

### BRIEF DESCRIPTION OF DRAWINGS

FIG. 1 is a perspective view of a trim component in prior art.

FIG. 2 is a side view of trim component in FIG. 1.

FIG. 3 is a plan view of of a trim component according to one embodiment of the present disclosure.

FIG. 4 is a side view of the trim component in FIG. 3 viewed from a direction A according to one embodiment of the present disclosure.

FIG. 5 is a cross-sectional view along a line A-A of the trim component in FIG. 3, illustrating the gap cover in a closed position.

FIG. 6 is a cross-sectional view of the gap cover in FIG. 3, illustrating the gap cover in an open position.

FIG. 7 is a cross-sectional of a trim component according to another embodiment of the present disclosure.

FIG. 8 is a cross-sectional view of a gap cover in a closed position according to another embodiment of the present invention.

FIG. 9 is a cross-sectional view of a gap cover in a closed position according to another embodiment of the present invention.

### DETAILED DESCRIPTION OF THE INVENTION

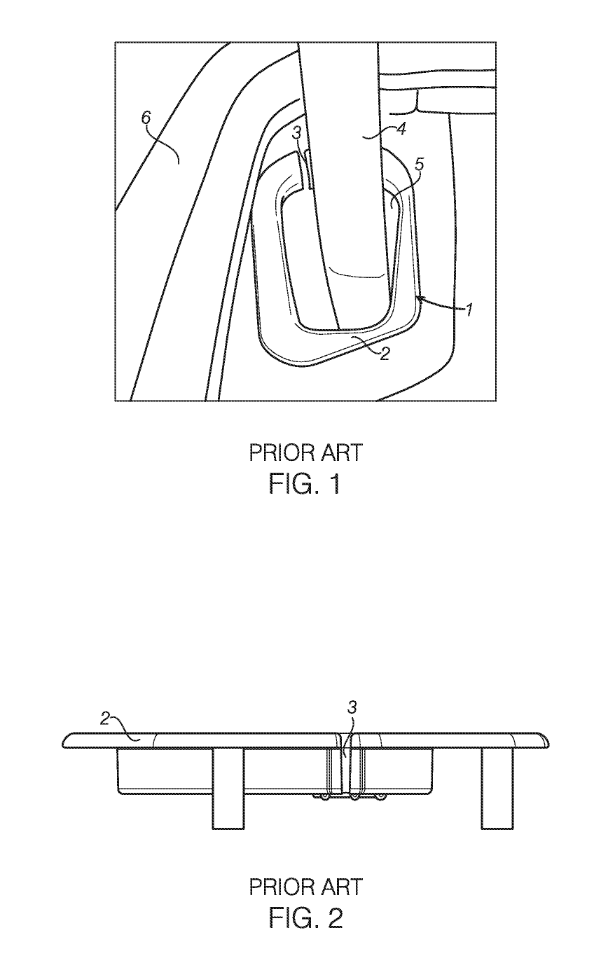

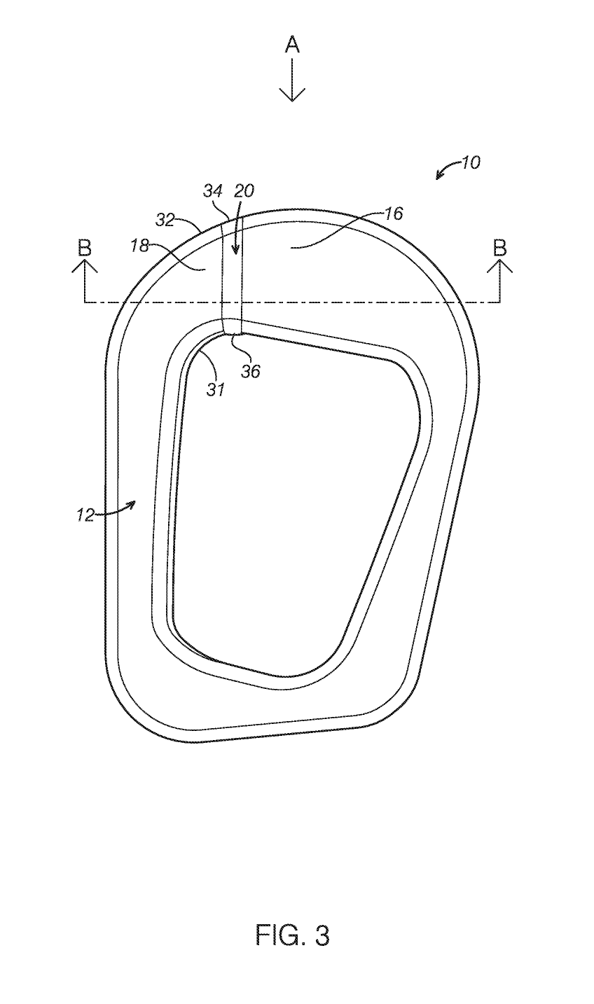

The trim component of the present disclosure is described with reference to the figures. As shown in FIG. 3, the trim component 10 may include a bezel 12 disposed on an inner trim of a trunk of a vehicle. With further reference to FIG. 1, the bezel 12 surrounds a hinge shaft that connects a trunk lid and the trunk body. the bezel 12 includes a first end 16 and a second end 18 spaced apart by an installation gap. The trim component 10 further includes a gap cover 20 pivotally connected on the first end 16 of the bezel 12 and moveable between an open position and a closed position. The gap cover 20 conceals the installation gap when the gap cover 20 is pivoted to a position adjacent to the second end 18 of the bezel and into the installation gap. The bezel may be a decoration bezel in a vehicle's trunk.

With further reference to FIG. 1, an inner trim of the vehicle trunk 6 has the opening 5 for the hinge shaft 4 to pass through. A trim component 10 may be used to encircle an edge of the hole 5 to cover an edge portion of the opening 5 for decoration purpose.

Continuing FIG. 3 and with reference to FIGS. 5, 6 and 1, during an installation, the gap cover 20 is pivoted to an opening position, at which the second end 18 is away from the gap cover 20 to expose an installation gap 14. Then, the bezel 12 is moved to pass the hinge shaft 4 via the installation gap 14 to surround the hinge shaft 4. Next, the bezel 12 may he squeezed to reduce the installation gap 14 and be pressed on the position covering the edge portion of the hole 5. Finally, the gap cover 20 is pivoted to cross the installation gap 14 and arrive at the closed position. At the closed position, the gap cover 20 is connected to the second end 18 of the bezel. It should be appreciated that the connection described above can be lap joint, clearance fit or any suitable approaches to achieve smooth transition between the bezel 12 and the gap cover 20. After the installation, as shown in FIG. 5, the bezel 12 and the gap cover 20 have smooth transition and there is no visible cut on the surface of the trim component, and thus the trim component 10 of the present disclosure has a better appearance.

In addition, during an application, the gap cover 20 at the closed position is disposed between the first end 16 and the second end 18 so that the installation gap 14 will not be reduced due to squeezing on the first and second ends 16, 18 to ensure the installation gap 14 is not decreased due to the squeezing to prevent the trim component 10 from moving and falling off due to the deformation.

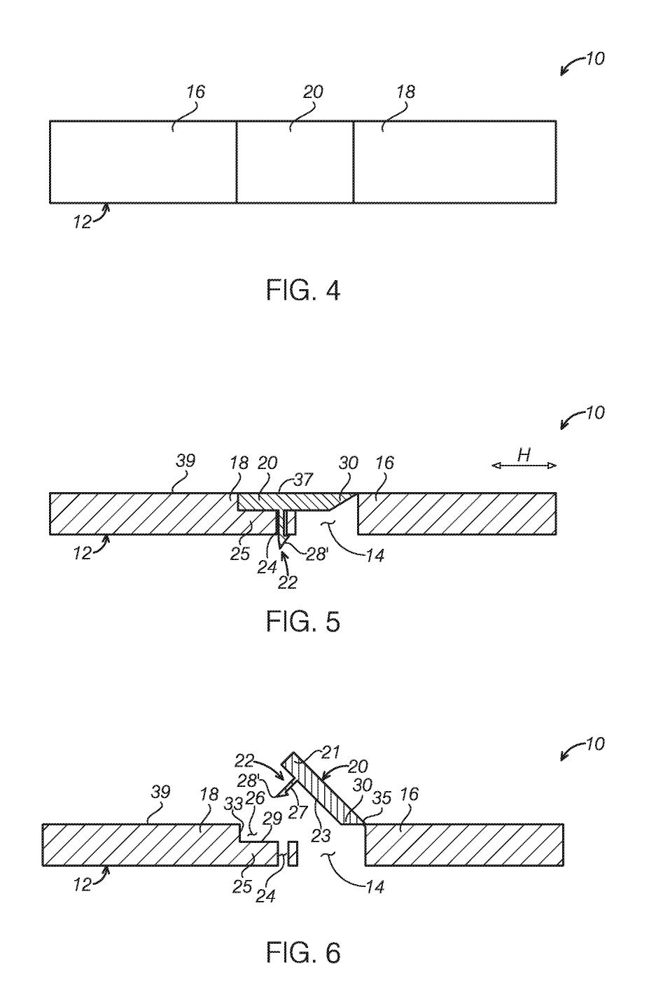

Now referring to FIGS. 4-6, an example embodiment of a trim component 10 is illustrated. FIG. 4 is a side view of the trim component in FIG. 3 viewed from a direction A according to one embodiment of the present disclosure, FIG. 5 is a cross-sectional view along a line A-A of the trim component in FIG. 3, illustrating the gap cover in a closed position, and FIG. 6 is a cross-sectional view of the gap cover in FIG. 3, illustrating the gap cover in an open position. As shown in FIGS. 4-6 the trim component 10 includes a bezel 12 having a first end 16 and a second end 18 spaced apart from the first end 16 by an installation gap 14. The trim component 10 further includes a gap cover 20 pivotally connected to first end 16. The gap cover 20 conceals the installing gap 14 when rotated to the closed position or the position connecting the second end 18. As described hereinafter elsewhere, the gap cover 20 may be pivotally moveable between an open position as shown in FIG. 6 and a closed position to conceal the installing gap 14 as shown in FIG. 5, that is, the gap cover 20 may be rotated from the open position to the closed position.

For purpose of illustration, the bezel 12 described in the present disclosure is shown as a ring-like shape part or loop-shaped bezel. The installing gap 14 may be at any position of the bezel. However, the bezel 12 may have any suitable configurations. For example, the bezel 12 may be two plate spaced apart and the gap cover 20 may be configured to conceal the installation gap 14.

As shown in FIGS. 5-6, to fix the gap cover 20 with the bezel 12 firmly, in some embodiments, the gap cover 20 may be formed with an insertion member 22. The gap cover 20 may include a base 21 and the insertion member 22 extended from a bottom surface 23 of the base 20. The second end 18 may include a bottom portion 25 recessed from a top surface 39 of the bezel 12. An upper surface 29 of the bottom portion 25 and a sidewall 33 above the upper surface 29 define a receiving slot 26. The bottom portion 25 of the second end 18 may include a hole 24 to receive the insertion member 22 to be connected with the gap cover 20. As such, after the gap cover 20 is located at the closed position, the hole 24 can limit the movement of the insertion member 22 to ensure that the gap cover 20 is not spring away due to squeezing or hitting, and prevents the trim component 10 from swing or collapsing into a stepped shape or even falling into an interior of the trim.

In the depicted embodiment, the gap cover 20 is formed with one end connecting the first end 16 of the bezel 12, and another end is formed with the insertion member 22. It should be understood that in alternative embodiments, any portions of the gap cover 20 may connect the first end 16 of the bezel 12, and the insertion member 22 may be disposed at any position on the gap cover 20.

In some embodiments, the second end 18 may include a receiving slot 26 defined by the top surface 29 of the bottom portion 25 and the sidewall 33, and at least a portion of the base 21 may be received in the receiving slot 26. It should be understood that, although the receiving slot 26 is disposed at an end portion of the second end 18, and formed with a stepped structure as shown in FIGS. 5-6, the receiving slot 26 may have any suitable configuration such as a groove or a hole on the second end and recessed at the second end 18. In the embodiments in which the receiving slot is formed at a surface of second end 18, one end of the gap cover 20 toward the receiving slot 26 may have a structure matched with the receiving slot 26 to prevent the gap cover 20 from spring out from the closed position.

In the embodiment in which the trim component 10 with the receiving slot 26, the sidewall 33 of the receiving slot 26 can function as a stop to an end portion of the gap cover 20 having the insertion member 22, and thus further limit the retraction and extension of the trim component 10 in the lateral direction H.

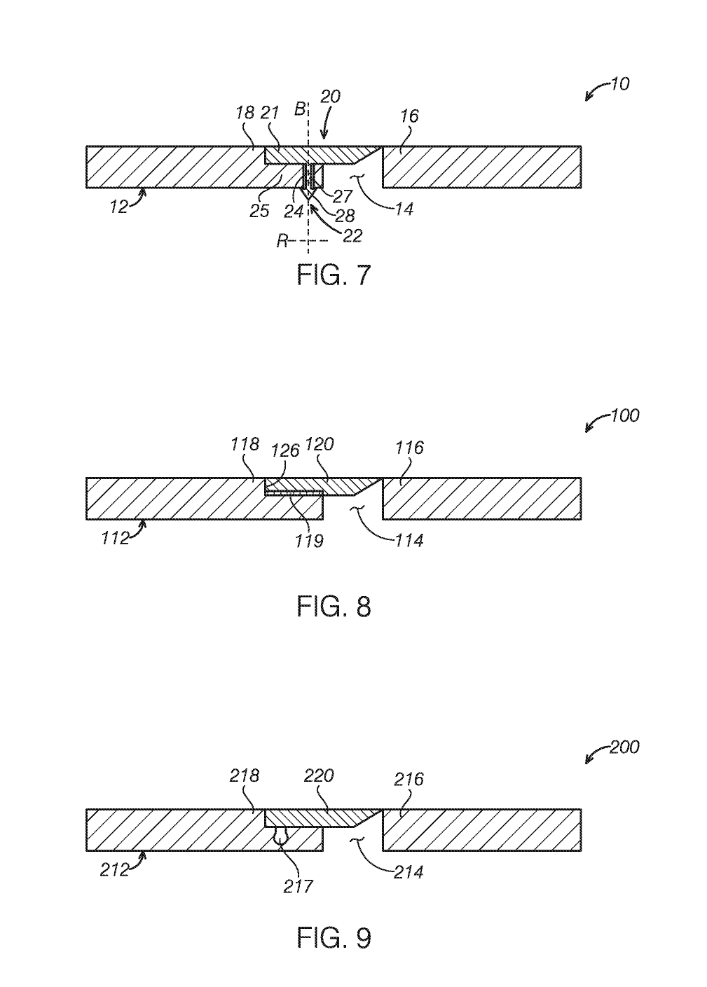

In some embodiments as shown in FIG. 7, the insertion member 22 may include a middle portion 27 and a stop 28 protruded from the middle portion 27 along R direction. The middle portion 27 may have a length greater than a thickness of a bottom portion 25 of the second end 18. When the gap cover 20 is at the closed position as shown in FIG. 7, at least a portion of the middle part 27 is received in the insertion hole 24, and the insertion hole 24 is positioned between the stop 28 and the base 21 at an axial direction B. In other words, the stop 28 and the base 21 hold the insertion hole 24 or the second end 18 to prevent undesired separation of the gap cover 20 from the second end 18.

In some embodiments, the gap cover 20 is fixed on the second end 18 at the closed position. The fixed connection as referred in this disclosure means that the gap cover 20 and the second end 18 is undetachable after they are connected. For example, as shown in FIG. 7, the insertion member 22 is configured to have the stop 28 surrounding its periphery. The stop 28 can be inserted into the insertion hole 24 and extended out of the insertion hole 24. The stop 28 exposed under the insertion hole stops the gap cover 20 from being removed away permanently. When the gap cover 20 is closed, the stop 28 is pressed into the insertion hole 24. The stop 28 passes through the insertion hole 24 when the gap cover 20 is at a fully closed position. The stop 28 may touch a surface of the second end that is opposite to an engaging surface of the second end 18 and the gap cover 20. That is, as shown in the depicted the embodiments, the stop 28 passes through the insertion hole 24 from a top surface of the second end 18 and contacts a bottom surface of the second end 18.

It should be understood that the stop 28 described above may have a conic shape as depicted in FIG. 7, or may be any suitable shape that is capable to achieve a connection between the gap cover 20 and the second end 18. For example, the stop 28 may be configured to have two opposite semi-sphere protrusion opposite to an axial direction of the insertion member. It should be understood that although FIG. 7 shows that the gap cover 20 and the second end 18 is fixed via the stop 28 disposed on an insertion member's periphery, any suitable approaches may be employed to achieve fixed connections such as connections by screw and nut or connection by welding.

According to another aspect, to facilitate replacement of the trim component 10 due to damage or worn out, the gap cover 20 may be detachably connected to the second end 18 at the connection position with the second end 18 or at the closed position. For example, as shown in FIGS. 5-6, the stop 28′ may be disposed partially on the periphery of the insertion member 22 or on one side of the insertion member 22, the extended portion of the stop 28′ can be disposed at outside of the hole 24 and pulled out from the hole. When the trim component 10 needs to be removed or replaced, the bezel 12 may be pushed in the axial direction of the insertion member 22 and the gap cover 20 is rotated to make the stop 28′ moving back into the hole 24, and the gap cover 20 is further rotated in direction away from the second end 18, until the stop 28′ is fully moved away from the hole 24 (as shown in FIG. 6) then the trim component 10 can be taken away via squeezing the bezel 12.

In some embodiments, the insertion member may be made from the elastic material. For example, the middle portion 27 and/or stop 28 may be partially made from the elastic material to assist the insertion of the stop 28 into the insertion hole 24.

FIG. 8 shows another embodiment of a trim component 100 according to another embodiment of the present disclosure. In the depicted embodiment, at least a portion of a gap cover 120 may be received in a receiving slot 126 formed at a second end 118 of a bezel 112. In the embodiment depicted in FIG. 8, the gap cover 120 may be connected detachably with a second end 118 via a hook-loop fastener 119 or a clip. It should be understood that the hook-loop fastener 119 may be disposed on the base 121 of the gap cover 120 and a portion, on the second end 118 corresponding to the base 21. One portion of the hook-loop fastener is soft fiber and another portion s elastic fiber with tiny hooks. When the gap cover 120 is closed, two parts are clipped together. When the gap cover 120 is opened, the elastic fiber with tiny hooks is pulled straight by pulling the gap cover 120 out, and released from the soft fiber, and then the tiny hooks are recovered to original state. In this way the gap cover 120 can be opened and closed repeatedly. Alternatively, both the gap cover 120 and the second end 118 of the bezel 112 may be connected with adhesive material.

Similarly, the snap-fitting device may include two parts disposed on the base 121 of the gap cover 120 and the second end 118 corresponding to the base, respectively. One part is a protrusion, and another part is a notch to receive the protrusion, and a restoring spring s disposed in the notch. When the gap cover 120 is closed, the protrusion presses the restoring spring to be snapped into the notch; and when the gap cover 120 is open by a pulling force, the protrusion presses to deforms the restoring spring to be released from the notch. It should be understood that the hook-loop fastener and the snap-fitting device are structures known in the art, and will not be describe in detail.

FIG. 9 depicts a trim component 200 according to another embodiment of the present disclosure. An auto-lock 217 may be disposed between a gap cover 220 and a second end 218 of a bezel 212 to detachably connect the gap cover 220 and the second end of the bezel 212. It should be understood that the auto-lock 217 is a lock with a mechanical lock function, that is, the gap cover 120 and the second end 218 are locked when a user first presses the gap cover 220 down and kept to be locked when a user first presses the gap cover 220; and unlocked when the user presses the gap cover 220 again so that the gap cover 220 is released from the second end 218. It should be understood that the auto-lock is a commonly known structure it the art and will not be described in detail.

In some embodiments, insertion member 22 and the hole 24 in the trim component 10 may be a clearance fit. An advantage for clearance fit between the insertion member 22 and the insertion hole 24 is that the insertion member 22 still can have small motion in the hole laterally when installed, thus, it is easy to adjust the overall position of the trim component 10. It should be understood, under some situation, the insertion member 22 and hole 24 also can be interference fit.

in some embodiments, the gap covers 20, 120 or 220 of may be formed integrally with the bezel 12, 112 or 212. In the embodiment depicted in FIG. 6, the gap cover 20 includes a thinner segment 30 adjacent to the first end 16 and having the connection portion 35 with a minimum thickness. The thickness refers to a measure at a direction substantially perpendicular from a plane of the gap cover 20 at the closed position. The connection portion 35 is connected with the first end 16 of the bezel 12 to form a pivot for the rotation of the gap cover 20. It should be understood that the connecting portion 35 may be referred as a hinge joint line. Alternatively, the gap cover 20 and the bezel 12 may be configured as an individual part, and connected with any appropriate manners. For example, a pivot shaft may be disposed between gap cover 20 and the bezel 12.

in some embodiments, if the gap cover 20 and bezel 12 are formed integrally as one piece, the trim component 10 may be molded integrally, and thus there is no extra procedure needed and thus simplify the manufacturing process. In addition, if the connection portion between the gap cover 20 and the first end 16 the bezel 12 is configured to have the minimum thickness, the pivoting of the gap cover 20 can be facilitated, and there will be no interfere between the gap cover 20 and other parts of the bezel 12.

In some embodiments, as shown in FIG. 5, at position of concealing the installation gap 14 or a closed position a top surface 37 of the gap cover 20 may be aligned with a top surface 39 of the bezel 12. In some embodiments, such as the embodiment shown in FIG. 3, at the closed position, two sidewalls 34 and 36 of the gap cover 20 are aligned with an inner sidewall 31 and an outer sidewall 32 of the bezel 12. As such, upon completion of installing the trim component 10, the trim component 10 will not have a visible cut and have a smooth transition between the gap cover 20 and the bezel 12 and thus providing better appearance. As described above, the inner sidewall 31 and the outer sidewall 32 of the bezel 12 refer to the inner surface of the inner sidewall 31 and the outer surface of the outer sidewall 32 when the bezel has a ring-shape.

For purpose of illustration, the trim component of the present disclosure is described with reference to the application in a vehicle's trunk. It should be appreciated that the trim component of the present invention can be used any part of the vehicle and the installation position of the trim component is not limited. The trim component of the present disclosure can be used in other fields such as airplanes, ships and building depending on the applications.

The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A trim component in a vehicle, comprising:
a bezel, wherein the bezel includes a first end and a second end spaced apart from the first end by an installation gap; and
a gap cover pivotally connected to the first end, wherein the gap cover conceals the installation gap when the gap cover is pivotally moved to a position connected with the second end of the bezel.

2. The trim component of claim 1, wherein the gap cover is fixed to the second end or detachably connected to the second end.

3. The trim component of claim 1, wherein the gap cover includes a base and an insertion member extended from a bottom surface of the base, and the second end includes an insertion hole to receive the insertion member to be connected to the gap cover.

4. The trim component of claim 3, wherein the second end include a receiving slot, and at least a portion of the base is received in the receiving slot and the insertion hole is formed on a bottom portion of the second end that define the receiving slot.

5. The trim component of claim 4, wherein the insertion member includes a middle portion at least partially received in the insertion hole and a stop extending from a radial direction of the middle portion, wherein the middle portion is disposed in the insertion hole and the stop is disposed under a bottom surface of the second end when the gap cover is at a position to conceal the installation gap.

6. The trim component of claim 3, wherein the insertion member and the insertion hole are clearance fit.

7. The trim component of claim 1, wherein the gap cover is detachably connected to the second end via, a hook-loop or snap fitting.

8. The trim component of claim 1, wherein an auto-lock is disposed between the gap cover and the second end and the gap cover and the second end is detachably connected via the auto-lock.

9. The trim component of claim 1, wherein the bezel and the gap cover is integrally formed.

10. The trim component of claim 9, wherein the gap cover includes a connection portion having a minimum thickness and the connection of the connection portion and the first end consists the pivot.

11. The trim component of claim 1, wherein a top surface of the gap cover is aligned with a top surface of the bezel.

12. The trim component of claim 1 wherein two sidewalls of the gap cover are aligned with an inner sidewall and an outer sidewall of the bezel, respectively.

13. A trim component in a vehicle, comprising:
a looped bezel including a first end and a second end spaced apart from the first end by an installation gap; and
a gap cover pivotally connected to the first end of the bezel, wherein the gap cover is moveable between an open position and a closed position and configured to conceal the installation gap at the closed position.

14. The trim component of claim 13, wherein the second end includes a bottom portion recessed from a top surface of the bezel, wherein an upper surface of the bottom portion and a sidewall above the upper surface define a receiving slot, and wherein the gap cover is disposed in the receiving slot at the closed position.

15. The trim component of claim 14, wherein the gap cover includes a base and an insertion member extended from a bottom surface of the base, wherein the bottom portion of the second end includes an insertion hole, and wherein the insertion member is positioned in the insertion hole at the closed position.

16. The trim component of claim 15, wherein the insertion member includes a middle portion having a length greater than thickness of the insertion hole and a stop at an end of the insertion member and extending from a radial direction of the middle portion, and wherein the stop is disposed under the bottom portion to fix the gap cover on the second end of the bezel at the closed position.

17. The trim component of claim 13, wherein the gap cover and the bezel are integrally formed, and the gap cover includes a connection portion adjacent to the first end and having a minimum thickness, and wherein the connection portion constitutes a pivot for rotation of the gap cover.

18. A trim component in a trunk of a vehicle, comprising:
a bezel, wherein the bezel is connected to an inner trim of the trunk, surrounds a hinge shaft of the trunk, and includes a first end and a second part spaced apart from the first end by an installation gap; and
a gap cover, wherein the gap cover is pivotally connected to the first end of the bezel and moveable between an open position and a closed position.

19. The trim component of claim 18, wherein the first end and the second end of the bezel are configured to be moveable relative each other at the open position such that the bezel is capable of being pass through the hinge shaft and being positioned on an opening on the inner trim.

20. The trim component of claim 18, wherein the gap cover is detachable connected to the second end or secured to the second end of the bezel at the closed position, and wherein the gap cover conceals the installation gap at the closed position.
